(19) United States
(12) Patent Application Publication
(10) Pub. No.: US 2010/0009122 A1
(43) Pub. Date: Jan. 14, 2010

(54) DEFORMABLE SUBSTRATE WITH MICROSTRUCTURED SURFACE COMPOSED OF APPLIED MATERIAL, AND METHOD FOR PRODUCING SUCH A SUBSTRATE

(75) Inventors: Stefan Schlayer, Stuttgart (DE); Bernhard Wiedemann, Rottenburg (DE); Frank Schlipf, Dietingen (DE)

Correspondence Address: PATENT CENTRAL LLC;Stephan A. Pendorf, 1401 Hollywood Boulevard, Hollywood, FL, 33020, US

(73) Assignee: Daimler AG, Stuttgart (DE)

(21) Appl. No.: 12/439,567

(22) PCT Filed: Sep. 28, 2007
(86) PCT No.: PCT/DE2007/001742

§ 371 Date: Mar. 2, 2009

(30) Foreign Application Priority Data
Sep. 29, 2006 (DE) 10 2006 046 764.7

(51) Int. Cl. B32B 3/10; B05D 5/00; B32B 38/10; B05D 1/00

(52) U.S. Cl. 428/141; 427/256; 156/230; 427/596

(57) ABSTRACT

The invention relates to a deformable substrate with microstructured surface composed of applied material, wherein the applied material is configured as individual pixels which have been printed onto the substrate.

The invention relates to a deformable substrate with a microstructured surface composed of applied material according to the preamble of claim 1 and a method for producing such a substrate according to the preamble of claim 6. These substrates and methods for their production are for example known from EP 193133 A2, DE 19644463 A1, DE 19834688 A1 and DE 10050642 A1.

Deformable substrates are often provided with coatings of other materials to modify their surface properties. Sealing profiles for motor vehicles are for example coated with lubricating lacquers to reduce interfering noises which are generated during the transfer of the adhering to the sliding friction (so-called stick-slip effect). Additionally, either the substrate surface or the lubricating lacquer is provided with a microstructure. The first version is for example described in DE 19644463 A1 or DE 19834688 A1. The second version is described in DE 193133 A2 or also in DE 10050642 A1, where the microstructure is inserted into the coating by stamping.

Lubricating lacquers are known to the expert e.g. from WO 02081582 A2 or DE 3839937 A1 and from [Matthis Kimmann: “Gleitlacke für Kunststoffe” in JOT 1999, no. 9, pages 60-65].

Experiments show that the known interfering noises of the stick slip effect can be oppressed very well with seals structured in such a manner. But this effect decreases considerably after longer use of the seals, that is, after several years.

It is thus the object of the present invention to specify a deformable substrate with microstructured surface composed of applied material and a method for producing such a substrate, which retain their properties caused by the microstructured surface for a longer time.

The invention is depicted in relation to the substrate to be created and the method to be created by the characteristics of claims 1 and 6. The further claims contain advantageous arrangements and embodiments of the substrate according to the invention and the method according to the invention.

The object is solved with regard to the deformable substrate with microstructured surface composed of applied material to be created, in that the applied material is configured as individual pixels.

Microstructuring means thereby that the pixels have maximum dimensions smaller than 1 mm and minimum dimensions larger than 1 nm, preferably smaller than 500 μm and larger than 10 nm, in particular smaller than 300 μm and larger than 50 nm.

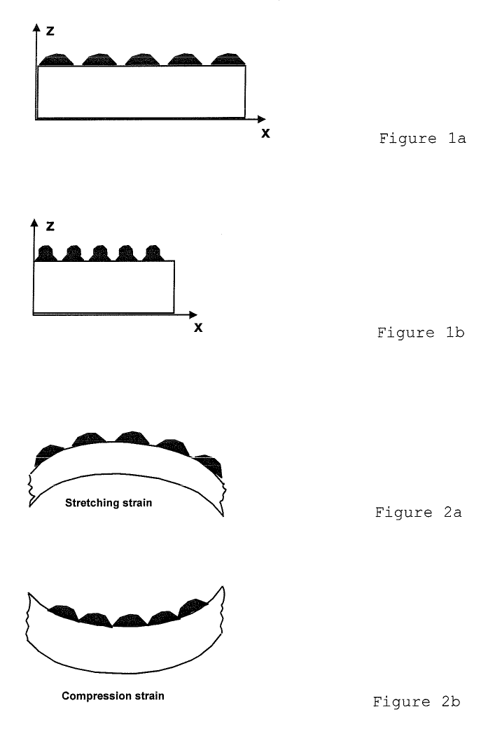

A pixel is the product of a solidification process of the applied material connected to the substrate, that is, it does not have any sharp edges, but has round contours. A pixel preferably consists of cured lacquer, in particular lubricating lacquer. The ratio of its maximum dimension parallel to the substrate surface and vertical to the substrate surface is preferably 5 to 1 or less, in particular 3 to 1 or less, that is, as a rule, a pixel “lies” rather flat on the substrate surface (see FIG. 1a). Applications in which the pixel is rather “upright” (see FIG. 1b), that is, has a dimension ratio of 1 to 3, in particular 1 to 5 or even more, are also feasible.

It is important that the pixels are individual, that is, have clearly defined boundary surfaces to their environment. They are thus either arranged in a spaced manner to adjacent pixels and their surface describes the boundary surface to the surrounding air. Or the pixels have a clearly defined boundary surface to adjacent pixels, for example due to different composition and/or different solidification times.

A deformable substrate according to the invention keeps its properties caused by the microstructured surface considerably longer than comparable deformable substrates of the state of the art. This is attributed to different effects of mechanical alternating strains due to deformation of the substrate surface:

According to the state of the art, brittle material is applied to a structured or also a non-structured deformable substrate surface in a continuous layer and possibly still structured at the surface. But the applied brittle material also remains connected between its possibly structured regions at least in a lower layer. During a deformation of the substrate and its surface, the applied brittle material layer experiences a mechanical alternating strain in the form of drag and/or pressure (compression and/or stretching). This alternating strain leads, in cooperation with material ageing, thermal strain, local notch effect by inserted fillers and contaminations and further influences, to a local crack formation of the brittle applied material layer. Once the brittle material is damaged, the mentioned influences can become effective more efficiently and lead to the delamination of the entire layer with increased speed.

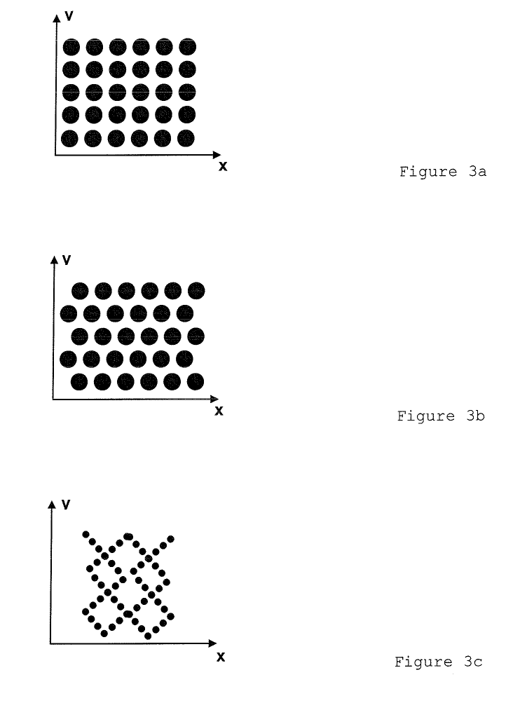

In contrast, the substrate according to the invention does not comprise a connected brittle layer which can delaminate extensively, but individual possibly brittle pixels, the extension of which parallel to the substrate surface is so low that no considerable alternating strain can be configured by compression or stretching (see the schematic and not to scale FIGS. 2a for the stretching strain and 2b for the compression strain of the substrate surface without corresponding strain of the pixels).

This fundamental difference of the invention compared to the state of the art causes its considerably temporally longer property preservation.

Further property improvements can be achieved when the deformable substrate comprises pixels of different properties, in particular pixels of different form and/or different size and/or different physical and/or chemical properties and or with different spacing and/or arrangement relative to one another. The arrangement is particularly a new mechanism for increasing the functionality of the applied material. A desired property as e.g. the sealing effect or the resistance to contamination can thus be optimized by for example a specific structure construction or by the generation of a functional topology.

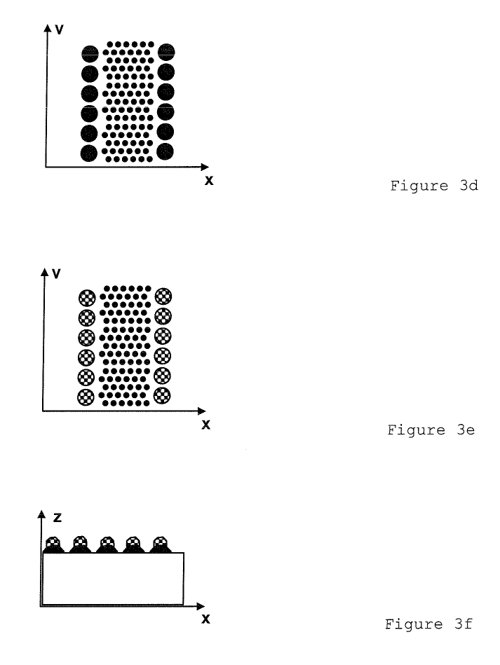

Differences in the form can be present in one, in two or in all three spatial axes, e.g. one pixel can be designed flatter (form difference in the z-direction) or more ellipsoidal (form difference in the x- or y-direction) than another. Examples of different arrangements of pixels are shown in FIGS. 3a to 3c. FIG. 3a shows the simplest arrangement possibility of completely even distribution and the same alignment of the pixels. FIG. 3b shows an even distribution of pixels arranged in an offset manner. FIG. 3c shows an uneven arrangement of pixels with different spacing in the form of a pattern. By means of suitable patterns, properties can be adjusted specifically on one hand, and also generate identification characteristics on the other hand, e.g. in the form of point or composed line or sign codings or can apply direct layout or mounting information onto the substrate. FIG. 3d shows a combination of differences in the pixel arrangement, the pixel spacing and the pixel size.

Differences in the physical properties can on the one hand be established in the form of the pixels, in particular their dimensions and dimension ratios (e.g. lotus effect) and on the other hand by their chemical composition, e.g. hydrophobic substances. FIG. 3e shows for example on the one hand comparatively large and densely adjacent pixels relative to their size of a hydrophobic substance which function as a water-repellant barrier layer in a schematic manner and not to scale. On the other hand, FIG. 3e shows comparatively small pixels of another substance which serve for the reduction of the stick slip effect and thus the noise reduction.

Furthermore, design aspects can be considered, by e.g. arranging pixels of one or several colored materials between lubricating lacquer pixels. These two additional aspects can also be combined. In particular, arbitrary characteristics can be described therewith, e.g. identification characteristics or attributes.

Only the sorted separated application of pixels having different functionality according to the invention enables these multiple functionalities. This was not possible up to now, as lubricating lacquers usually comprise complex compositions, which are exactly adjusted to their necessary functionality and which would always disturb this necessary functionality and the addition of further components for other uses.

It is advantageous if the pixels of additional, particularly subordinate functionality have a lower height than the pixels of the basic functionality, e.g. the lubricating lacquer pixels. The basic functionality is thereby not impaired in any manner and the subordinate function is simultaneously enabled.

Further possibilities for the specific adjustment of surface properties result from pixels which comprise different properties vertical to the substrate surface, in particular composition (see FIG. 3f for this). The differences can thereby be present vertical to the substrate surface with every pixel in the same manner, or also be designed different between different pixels.

Suitable deformable substrates are e.g.: plastics, in particular elastomers, natural substances, in particular leather, clay, textiles.

These substrates with a corresponding microstructured surface can e.g. be used as sliding components such as seals, bellows or windscreen wipers, as mounting or shaping aids, or also as components which are in danger of oscillation wear.

The object is solved with regard to the method to be created for the production of a microstructured surface on a deformable substrate by applying material in that the material is applied in the form of individual pixels.

The substrate produced according to the invention does thereby not comprise a connected brittle layer which can delaminate extensively, but individual microstructures or pixels, the extension of which parallel to the substrate surface is so low that no considerable alternating strain can be configured by compression or stretching.

The material is preferably applied in liquid form, in particular lacquer, e.g. lubricating lacquer. Known printing methods as e.g. mentioned in DIN 16500 with further references are particularly suitable for the application, e.g. relief printing, gravure printing, flat printing, screen printing. Electronic printing methods without printing plate, in particular by means of inkjet or laser printing or other illumination methods are also possible. Printing methods without printing plates have the advantage that they can be used fundamentally easier on arcuate surfaces than those with a printing plate. Laser printing is thereby particularly suitable, as it is subject to gravity influences in a considerably lesser amount than with inkjet printing.

By means of these printing methods, the pixels can either be printed directly on the substrate surface or first be printed on a peel-off film and then be transferred therefrom to the substrate surface. The last version is primarily advantageous with those surfaces which have highly arcuate surfaces in their resting state. It is furthermore advantageous if pixels with different properties are applied, in particular pixels with different form and/or different size and/or different physical and/or chemical properties and/or are applied relative to one another with different spacings. This can for example take place by means of applications in a time-delayed manner, in particular printing processes. But it can also take place simultaneously, e.g. by inkjet printing with differently filled and/or differently controlled multiple printing heads. Suitable multiple printing heads are commercially available, in particular in the material-applying region of the generative rapid technologies.

It is furthermore advantageous if pixels are applied which comprise different properties vertical to the substrate surface, in particular composition, preferably in such a manner that a pixel layer with a first property is initially applied, and subsequently one or several further pixel layers with one or several other properties. The differences can thereby be designed vertical to the substrate surface with each pixel in the same manner and also in a different manner between different pixels.

It is also advantageous if the pixels are arranged in the form of a pattern.

The method according to the invention and the substrate according to the invention is explained in more detail in the following:

According to a first embodiment, a substrate of a flexible elastomer (e.g. a sealing blank) is positioned in a flat manner. A microstructure of lacquer pixels is printed on the even substrate surface by means of a multiple inkjet printing head (here a piezo printer). For this, pixels of a hydrophobic substance are printed on the substrate surface from a first printing head and pixels of a substance reducing the adhering friction on an opposite surface. FIG. 3e shows for example on the one hand comparatively large and densely adjacent pixels of a hydrophobic substance which function as a water-repellant barrier layer in a schematic manner and not to scale. On the other hand, FIG. 3e shows comparatively small pixels of another substance which serve for the reduction of the stick slip effect and thus the noise reduction.

According to a second embodiment, a substrate of leather is first thinly coated with a curable liquid lubricating lacquer in a laminar manner. This can take place e.g. by means of spraying, spreading or immersion. This laminar coating is now cured locally pixel by pixel by means of a laser beam. Subsequently, the non-cured layer material is drawn off or rinsed off. A post-curing step can also take place if necessary.

This method has the advantage that even non-planar substrate surfaces can be coated more easily, as the laser beam can impinge the liquid layer from arbitrary directions and under arbitrary angles and is thereby not subject to noteworthy influences of gravity. The liquid layer is also not subject to noteworthy gravity influences due to its low thickness of about 0.005 to 0.5 mm, as its surface tension compensates these influences. Suitable robot-guided laser scanning systems for punctiform laser radiation from arbitrary spatial directions which can be changed quickly are now widespread and are becoming more economical. But the method naturally also functions with a stationary laser and a planar substrate surface.

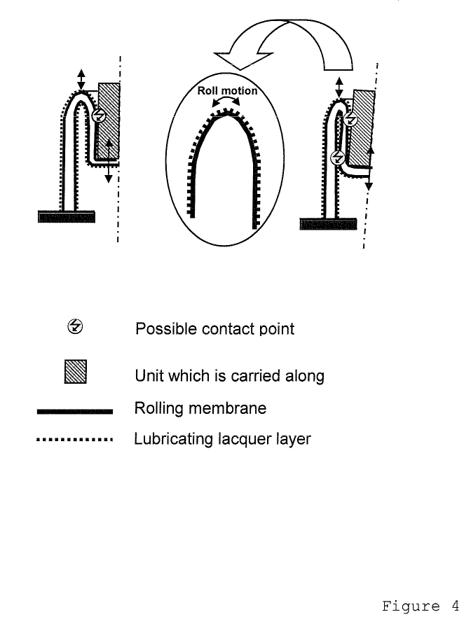

According to a third embodiment, an elastic rolling membrane of rubber is positioned in a flat manner. A simple microstructure of lubricating lacquer pixels is printed on its planar surface by means of a piezo inkjet printing head according to FIG. 3a onto the membrane surface. The lubricating lacquer is an air-curing PU resin with solid lubricating particles of PTFE dispersed therein. The other side of the rolling membrane is printed with the same microstructure of lubricating lacquer pixels. After the curing of the pixels, the rolling membrane is mounted to its field of application according to FIG. 4. Depending on the position of the components movable relative to one another, which are connected by means of the rolling membrane, the frictional contact adjusts between different sections of the rolling membrane and/or between the rolling membrane and a component surface. The printed microstructure removes the stick-slip effect and the noises resulting therefrom in the long term and increases the life cycle of the rolling membrane.

The substrate according to the invention and the method according to the invention prove to be particularly suitable in the embodiments of the above-described examples for the improved production of sliding components, e.g. sealing systems or bellows (rolling membrane), as are often used particularly in the automotive industry.

According to the invention, the life cycle of the properties caused by the microstructured surface is considerably increased. The properties can additionally be varied in a considerably easier manner. Furthermore, the use of coating material is reduced, which again leads to a protection or resources and relief of the environment. Further, mounting conditions can be improved by applying mounting instructions simultaneously.

The invention is not restricted to the examples shown, but can be transferred to others. E.g. pixels can also be applied to other substrates, which are e.g. plastically or elastically deformable, in particular metallic.

It is also feasible to apply a final elastic coating layer, e.g. of silicon, over the material applied as the individual pixel. Due to the elasticity of the coating layer, the advantage of the pixel-type application according to the invention is not affected. It is important that the pixels are still individual in this case, that is, have clearly defined boundary surfaces to their environment.

1. A deformable substrate with microstructured surface composed of applied material, wherein the applied material is configured as individual pixels.

2. The deformable substrate according to claim 1, wherein the pixels are composed of a cured coating.

3. The deformable substrate according to claim 1, wherein it comprises pixel of different properties, in particular pixels of different form and/or different size and/or different physical and/or chemical properties and or with different spacing and/or arrangement relative to one another.

4. The deformable substrate according claim 1, wherein it comprises pixels which comprise different properties vertical to the substrate surface.

5. The deformable substrate according to claim 1, wherein the pixels are arranged in the form of a pattern.

6. A method for the production of a microstructured surface on a deformable substrate by applying material, comprising applying the material in the form of individual pixels.

7. The method according to claim 6, comprising applying material in liquid form.

8. The method according to claim 6, comprising applying pixels with different properties.

9. The method according to claim 6, wherein pixels are applied which comprise different properties vertical to the substrate surface, in particular composition, preferably in such a manner that a pixel layer with a first property is applied initially, and subsequently one or several further pixel layers with one or several other properties.

10. The method according to claim 6, wherein the pixels are arranged in the form of a pattern.

11. The method according to claim 6, wherein the pixels are printed, preferably by means of screen printing or an electronic printing method without printing plate.

12. The method according to claim 6, wherein the pixels are first printed onto a peel-off film and are then transferred from there to the substrate surface.

13. The deformable substrate according to claim 2, wherein the cured coating is lubricating lacquer.

14. The deformable substrate according claim 4, wherein it comprises pixels which comprise different composition vertical to the substrate surface.

15. The method according to claim 7, comprising applying material as a laquer.

16. The method according to claim 7, comprising applying material as a lubricating lacquer.

17. The method according to claim 8, comprising applying pixels with at least one of:
different form,
different size,
different physical properties,
different chemical properties, and
different spacings relative to one another.

18. The method according to claim 9, wherein pixels are applied which comprise different composition vertical to the substrate surface.

19. The method according to claim 9, wherein pixels are applied which comprise different properties vertical to the substrate surface, in such a manner that a pixel layer with a first property is applied initially, and subsequently one or several further pixel layers with one or several other properties.

20. The method according to claim 11, wherein said printing is by means of inkjet or laser printing.
